(19) United States
(12) Patent Application Publication
(10) Pub. No.: US 2006/0174027 A1
(43) Pub. Date: Aug. 3, 2006

(54) Method and apparatus for transmission queue in communication system

(75) Inventors: Jin-Ho Kim, Incheon-si (KR); Kab-Joo Lee, Seongnam-si (KR)

Correspondence Address: F. CHAU & ASSOCIATES, LLC, 130 WOODBURY ROAD, WOODBURY, NY, 11797, US

(73) Assignee: Samsung Electronics Co., LTD, Suwon-si (KR)

(21) Appl. No.: 11/341,265

(22) Filed: Jan. 26, 2006

(30) Foreign Application Priority Data
Jan. 31, 2005 (KR) 2005-08677

(51) Int. Cl. G06F 15/16

(52) U.S. Cl. 709/231

(57) ABSTRACT

Disclosed is a wireless LAN system comprising: a memory; a central processing unit segmenting data, which is to be transferred, into frames, generating descriptors containing frame addresses and lengths in the memory, and storing the segmented frames and the descriptors into the memory in accordance with transmission priorities; a media accessing controller calling the frames of data, which is to be transferred, from the memory with reference to the transmission priorities and the descriptors, and temporarily storing the frames; and a transmitter transferring the frames stored in the media accessing controller. It is possible to improve data transmission speed and control facility, satisfying the quality of service for a standard of communication protocol.

### CROSS-REFERENCE TO RELATED APPLICATIONS

This U.S. non-provisional patent application claims priority under 35 U.S.C. § 119 of Korean Patent Application 2005-08677 filed on Jan. 31, 2005, the entire contents of which are hereby incorporated by reference.

### BACKGROUND

The invention relates to data transmissions with priority in wireless LAN systems and more particularly, to a method and apparatus for medium access control (MAC) to improve quality of service (QoS) by transmitting data from a transmission queue in compliance with priority defined in IEEE802.11e standard.

Nowadays, wireless LAN systems are widely used in varieties of wireless user environments such as home networks, wireless networks for enterprises, hot spots, and so on. Commercial wireless LAN systems conventionally used, as a scheme extended from the Ethernet system, are just capable of providing Best Effort services on basis of IEEE802.11b standard founded in 1999. But, users of wireless LAN systems desire to completely transfer multimedia streams without loss in transmission data. Especially, it is essential for new applications in recent, such as video streaming or multimedia streaming, to be benefited with good Quality of Service (QoS) even in wireless LAN environments. Continuous requirements for bandwidth extension by users are causing to increase the complexity and to decrease the transmission speed in the overall wireless network system. Therefore, in purpose of offering services for applications strictly requiring QoS even in network systems with high complexity, network managers need new mechanisms. Such requirements activate the study for improving medium access control (MAC) protocols in the conventional wireless LAN environments.

As the IEEE802.11 wireless LAN system does not define an priority order for frames coming down from an upper layer, the MAC layer transmits frames by means of queuing with a single first-in/first-output (FIFO) memory in the order of arrival. This is a kind of frame transmission without regarding the use frequency and characteristic of the MAC frame, which is improper to the frame transmission scheme that requires QoS in the same level with audio or video data. In order to correct the shortcoming of frame transmission and to improve QoS in the MAC layer, the specification of the IEEE802.11e classifies data on basis of priorities by access categories for frames coming down from an upper layer. The following Table 1 arranges the classification by access categories defined by the IEEE802.11e standard. The IEEE802.11e standard uses four access categories to differentiating the priority of IEEE802.1D that is a protocol of an upper layer.

TABLE 1

| Prior- | | | Access | |
|---|---|---|---|---|
| ity | Priority | Designation | Category | Destination |
| level | (IEEE802.1D) | (IEEE802.1D) | (IEEE802.11e) | (IEEE802.11e) |
| Low- | 1 | BK | AC_BK | Background |
| est | | | | |
| | 2 | — | AC_BK | Background |
| | 0 | BE | AC_BE | Best effort |
| | 3 | EE | AC_BE | Best effort |
| | 4 | CL | AC_VI | Video |
| | 5 | VI | AC_VI | Video |
| | 6 | VO | AC_VO | Voice |
| High- | 7 | NC | AC_VO | Voice |
| est | | | | |

As can be seen from the Table 1, for the purpose of enhancing the QoS in the IEEE802.11e standard, Voice frame has the highest priority while Background has the lowest priority. In the MAC layer, frames differentiated by the access categories (AC) are stored in a memory by means of transmission queues by the access categories. The frames stored in the memory as such need to be transferred in the priorities, so the following description provides a configuration of a transmission queue by the access categories in the memory and a hardware architecture to transmit frames in accordance with the priorities.

### SUMMARY OF THE INVENTION

The invention is directed to solve the aforementioned problems, providing a method and apparatus for implementing the configuration of queue in priorities and for transferring queue frames, which are stored with priorities in a memory, to a transmitter. The invention enhances the transmission speed and efficiency, assuring the improvement of QoS in a wireless LAN system.

An aspect of the invention is a wireless LAN system being comprised of: a memory composed of frames arranged in plural queues with priorities by access categories; and a queue fetch engine transferring the frames from the queues to a transmitter in consideration with the priorities. The transmitter transfers the frames, which are transferred in the order of the priorities, under control of the queue fetch engine.

In a preferred embodiment, the memory is composed of the plural transmission queues each occupying specific regions in the memory. The queue according to the invention is constituted of three regions for descriptor, frame headers, and frame body. A single transmission queue stores plural frames with the same priority and descriptors representing the frames. Through the structure of the memory, it implements the queue for assisting transmission environments with access categories defined by IEEE802.11e standard.

In a preferred embodiment, the queue fetch engine requests the transmitter for transfer and transmission of the frames stored in the queue of the memory, and exchanges information about transmission results and conditions with the transmitter. Further, the invention includes a function to control the frame transfer operation for the queues having the priorities.

In a preferred embodiment, the transmitter sends the frame requested by the queue fetch engine and informs the queue fetch engine of a result of transmission, being configured to be properly operable with the queue fetch engine when there is a transmission error.

### BRIEF DESCRIPTION OF THE DRAWINGS

The accompanying drawings are included to provide a further understanding of the invention, and are incorporated in and constitute a part of this specification. The drawings illustrate example embodiments of the invention and, together with the description, serve to explain principles of the invention. In the drawings:

FIG. 1 is a schematic block diagram of a transmission system in accordance with the invention;

FIG. 2 is a memory map illustrating the feature of implementing a transmission queue by the invention;

FIG. 3 is a block diagram illustrating the structure of a queue fetch engine (QFE) by the invention;

FIG. 4 is a block diagram illustrating the structure of a queue control unit (QCU) cell included in the QFE shown in FIG. 3;

FIG. 5 is a flow chart showing an operation of the queue controller; and

FIG. 6 is a flow chart showing an operation processing more two frames in the queue controller.

### DETAILED DESCRIPTION OF PREFERRED EMBODIMENTS

Preferred embodiments of the invention will be described below in more detail with reference to the accompanying drawings. The invention may, however, be embodied in different forms and should not be constructed as limited to the embodiments set forth herein. Rather, these embodiments are provided so that this disclosure will be thorough and complete, and will fully convey the scope of the invention to those skilled in the art. Like numerals refer to like elements throughout the specification.

Hereinafter, it will be described about an exemplary embodiment of the invention in conjunction with the accompanying drawings.

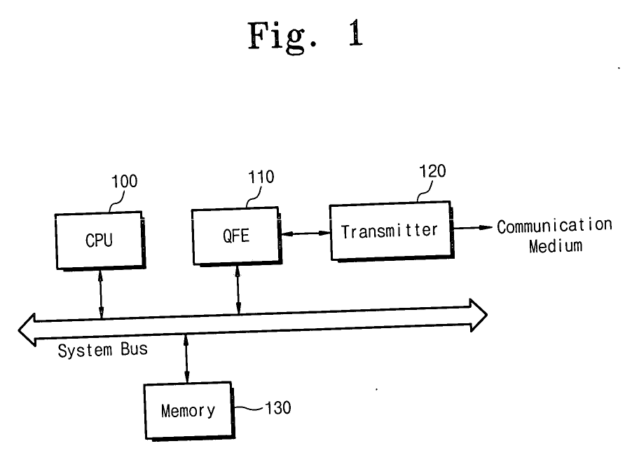

FIG. 1 is a schematic block diagram of a transmission system in accordance with the invention. Referring to FIG. 1, the transmission system moving transmission queue data is comprised of a central processing unit (CPU) 100 operating the transmission system with software, a memory 130 storing a plurality of queue data from frames to be transferred, a queue fetch engine (QFE) 110 transferring frames that are waiting in the order of priorities satisfying the QoS according to the IEEE802.11e standard after fetching the queue data stored in the memory 130, and a transmitter 120 of wireless physical layer transmitting frames that are transferred by the QFE 110.

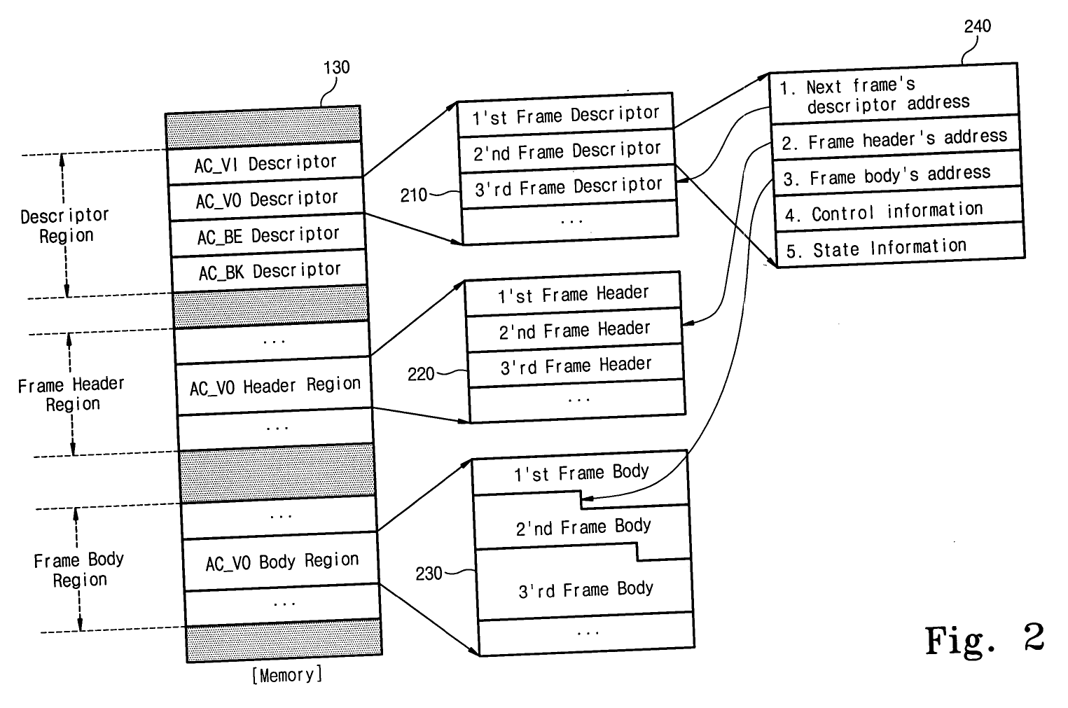

The CPU 110 functions to generally control data transception (transmission and reception) by means of software or wireless LAN driver provided thereto. The CPU 100 composes transmission queues, according to the invention, from classifying data by priorities and then stores them into the memory 130 as shown in FIG. 2. The CPU 100 functions to prosecute operations including signal processing steps that are carried out each at layers of the wireless LAN, and to determine operational flows. For the aforementioned operations, the CPU 100 may be constituted even with an additional RISC processor or a powerful DMA controller. Also, it is available for the CPU 100 to be operable with other functions not limited hereto.

The memory 130 is provided to store frames, to be transmitted, which are composed in the form of transmission queues differentiated by the access categories. Data to be transferred are segmented into three regions in accordance with control by the CPU100. The three regions, forming the data to be transferred, stores a frame scripter characterizing its corresponding frame to be transferred, a frame header corresponding to data for composition at a reception site of the frame to be transmitted at reception site, and a frame body containing the data to be transmitted. The structure of the transmission queue will be described in detail later with reference to FIG. 2.

The QFE 110 conducts a general operation to transfer frames from the transmission queues to the transmitter 120 in accordance with the priorities satisfying the IEEE802.11e standard. When the QFE 110 requests the transmitter 120 to move and transmit the frames stored in the transmission queues, it is occurred of exchange with information about transmission confirmation and other communication states between the QFE 110 and the transmitter 120. Especially, the QFE 110 contributes to enhancing the QoS, for which it transfers a higher-priority frame first to the transmitter 120, under considering the priorities of transmission, when frames are simultaneously prepared in several queues.

With reference to the system architecture including the aforementioned components and the configurations of the queues with the priorities including the frame descriptor of the memory 130, the QFE 110 is helpful for constructing an MAC satisfying the QoS defined in the IEEE802.11e by transferring a higher-priority frame first to the transmitter 120 in data transmission.

FIG. 2 is a memory map illustrating the feature of implementing the transmission queues by the access categories classified in accordance with the priorities set by the invention. Referring to FIG. 2, the memory 130 is basically composed of three regions segmented by the CPU 100. The CPU 100 segments data, which is to be transmitted, in accordance with the priorities by the access categories, and stores the data segments in the transmission queues of the priorities in correspondence with the frame descriptor region, the frame header region, and the frame body region. In the three regions, the frame descriptor region contains an address and length of the frame data in the memory 130, a position of the next frame with the same priority as the current frame, and information about control and condition of the frame data. The frame header region defines presence or absence of another frame relevant logically or physically to the stored frame. And, the frame body region corresponds to the data itself to be transferred. In this embodiment, the frame descriptor region, the frame header region, and the frame body region are each classified into four sections in consideration with the priorities by the access categories. The four access categories by the priorities are able to be associated with four queues for each region (200).

For instance, the descriptor region is composed of an AC_VI descriptor containing information of a frame corresponding to a video signal, an AC_VO descriptor containing information of a data frame corresponding to an audio signal, an AC_BE descriptor containing information of a Best Effort frame corresponding to general data, and an AC_BK descriptor containing information of a Background frame corresponding to other factors. This composition with such four sections is also configured in the frame header region and the frame body region, as like the descriptor region.

The descriptor region is segmented into the four sections in accordance with the priorities by the access categories. In FIG. 2, while the AC_VO descriptor is illustrated in detail as an example, the configurations of other descriptors are as same as that. This configuration of the descriptor is a core feature of the transmission queue in the invention. As also, this queue structure is configured as same in the descriptor of a frame with another priority. In this embodiment, as shown in FIG. 2, the descriptor, as one of the four descriptors standing by on the transmission queue, is composed of: a first field of “The next frame's descriptor address” that designates a descriptor of a frame waiting for the next priority; a second field of “Frame header's address”; a third field of “Frame body's address” as a body of the frame designated by the descriptor; a fourth field of “Control information” for regulating transmission of frame designated by the descriptor; and a fifth field of “state information” for storing a transmission result (240).

The descriptor is composed of information to transferring the frame header 220 and the frame body 230 stored in the memory 130. As the configuration of the descriptor aforementioned provides a segment address and length information of a large-capacity frame body, it makes possible to easily control calling and transferring the frame only by deciphering the descriptor. In addition, the queue control scheme, which adds or removes a descriptor, a frame header, and a frame body to or from each transmission queue, is accomplished by means of software corresponding to a wireless LAN driver. The software arranges the transmission queues in the memory 130 and commands the QFE 110 to transmit data.

Through the aforementioned queue configuration, the QFE 110 conducts a series of determining operations from reading only the descriptor of the transmission queue. As the QFE 110 has an address for the next descriptor standing by therefor, it is able to determine and control conditions of queue transmission according to the priorities just by transferring and storing only the descriptor without transferring all information about one frame.

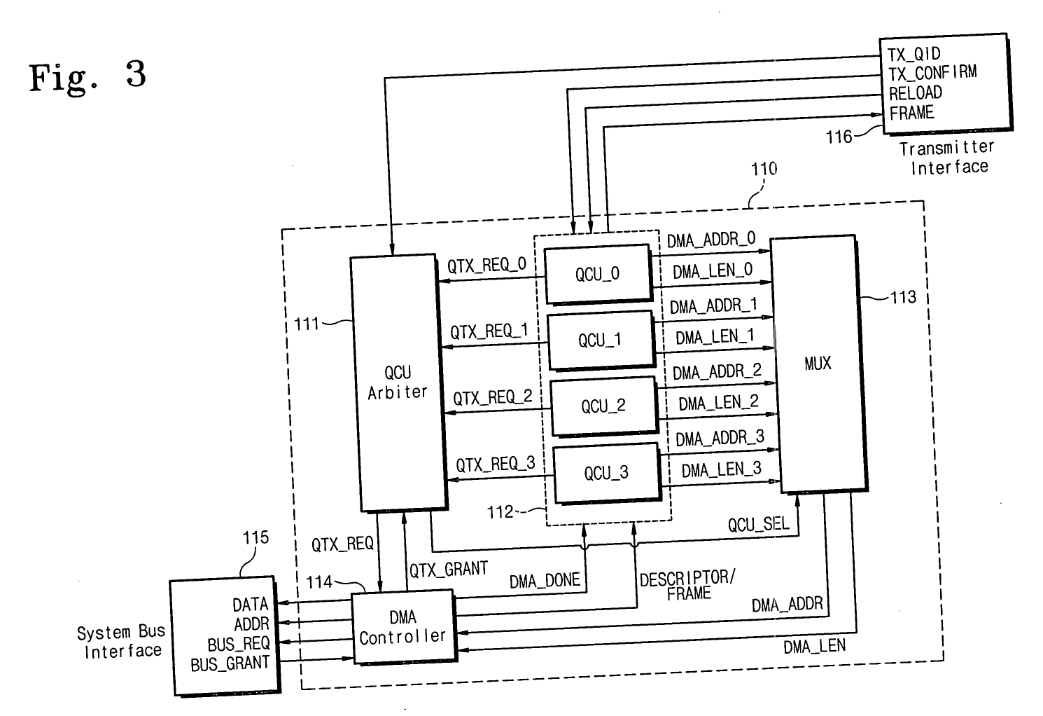

FIG. 3 is a block diagram schematically illustrating the structure of the QFE 110 by the invention. Referring to FIG. 3, the QFE 110 is comprised of: a queue control unit (QCU) block 112 including four QCU cells each regulating transmissions of the queues; a QCU arbiter 111 requesting the queue transmission from selecting transmission-requesting signals independently generated from the four QCU cells; a DMA controller 114 accepting the transmission request from the QCU arbiter 111 and taking charge of interfacing directly with a system bus reading the requested queue from the memory 130; and a multiplexer 113 transferring information of each queue frame to the DMA controller 114 in compliance with a result by the QCU arbiter 111.

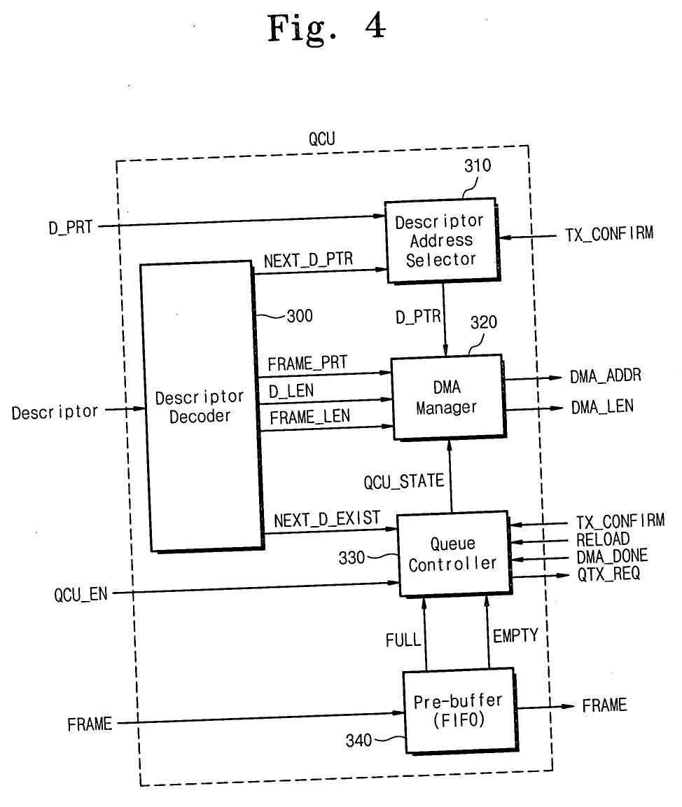

The QCU block 112 includes the QCU cells, which are provided to regulate transmission operations, in number as many as that of the transmission queues by the access categories composed in the memory 130 in order to assure independent transmission every queue. For example, the four QCU cells need to assist the transmission in accordance with the priorities by the access categories of the IEEE802.11e. Further, the QCU block 112 is provided to interface with the software for each transmission queue, and generates the transmission-requesting signals for corresponding queues in response to the software corresponding to an operating system or a wireless LAN driver. It will be described about the structure and operation of the QCU block in detail with reference to FIG. 4. The QCU block 112 shown in FIG. 3 is composed of four QCU cells, generating the transmission-requesting signals for corresponding queues, QTX_REQ0, QTX_REQ1, QTX_REQ2, and QTX_REQ3 (hereinafter, referred all to as QTX_REQ_x), those signals being applied to the QCU arbiter 111. In addition, the QCU block 112 is provided with the descriptor addresses, which are information about frames stored in transmission queues, by software, and enables the memory 130 to output information about the frame addresses and sizes by the access categories.

The QCU arbiter 111 functions to select one of the transmission-requesting signals QTX_REQ_x, which are independently generated at the same time from the QCU block 112, in accordance with the priorities by the access categories. This function is provided to arbitrate an authority of using the DMA because it is impossible for the plural QCU cells to share the DMA at the same time. The QCU block 112 transfers each of the transmission-requesting signals QTX_REQ_x to the QCU arbiter 111 in accordance with the necessity of transfer and transmission with the descriptor or the frame by each queue. The QCU arbiter 111 transfers the highest prior one of the transmission-requesting signals to the DMA controller 114 with reference to the transferred transmission-requesting signals QTX_REQ_x and signals TX_QID transferring with checking the queue that is being out of the transmitter 120. Meanwhile, the QCU arbiter 111 also transfers a signal QCU_SEL to the multiplexer (MUX) 113, enabling the multiplexer 113 to select an address or size of the transmission-requested descriptor or frame in the memory 130.

The DMA controller 114 receives a queue transmission-requesting signal QTX_REQ that is transferred from the QCU arbiter 111 with priority selection, and then requests the system bus for bus occupation. The DMA controller 114 also receives signals, DMA_ADDR and DMA_LEN, informing of an address and length of the frame in the memory 130, from the QCU cell corresponding thereto, and then conducts a DMA operation for transferring the descriptor or frame corresponding thereto. Completely transferring the corresponding descriptor and frame, the DMA controller 114 applies a signal DMA_DONE informing the corresponding QCU cell of the end of the DMA operation.

The multiplexer 113 inputs signals, DMA_ADDR_x and DMA_LEN_x, informing frame addresses and lengths that are generated independently for the QCU cells in the memory 130, and then transfers the information about the addresses and lengths to the DMA controller 114 with reference to the information signal QCU_SEL for a transmission queue selected by the priorities in the QCU arbiter 111.

The QFE 110 is also connected with a system bus interface 115 and a transmitter interface 116.

The system bus interface 115 is provided to communicate with the system bus to accept the requested descriptor or frame from the transmission queues formed in the memory 130. An operation of the system bus may not be limited to this embodiment.

The transmitter interface 116 transfers data frames to the transmitter 120, and transfers the information signal TX_QID about a currently transferred frame, a transmission-confirming signal TX_CONFIRM, and a re-transferring signal RELOAD to the QFE 110. In other words, the transmitter interface 116 conducts a series of interfacing operations between the transmitter 120 and the QFE 110, transferring data to the transmitter 120 and transferring the transfer-conditioning information to the QFE 110.

As stated above, in the embodiment of the invention, the QCU cells of the QCU block 112 generates the four transmission-requesting signals QTX_REQ_x (x=0, 1, 2, 3), respectively, for use in transmitting queues. And, the QCU arbiter 111 selects one of the four transmission-requesting signals QTX_REQ_x in consideration with the priorities of queue transmission and a currently transferred queue. The IEEE802.11e defines such that an access category with higher priority is rendered to have more chances of transmission by differentiating the priorities of wireless channels by the access categories. In establishing the authority of using the DMA, the QCU arbiter 111 enables data with higher priority to be transferred from the memory 130 by using the priorities by the access categories. For instance, if there are the transmission-requesting signals QTX_REQ_x simultaneously from the QCU cell controlling an access category with higher priority and from the other QCU cell controlling another access category with lower priority, the QCU arbiter 111 permits the higher-priority access category the authority of DMA use. Thereby, the access category with higher priority is able to transfer its corresponding frames faster, which improves the QoS thereof. Furthermore, for a queue being transmitted at present from the transmitter 120, it assures the current queue of the highest priority, regardless of the priorities assigned to the access categories, until its corresponding frames are completely transferred.

FIG. 4 is a block diagram illustrating the structure of the QCU cell included in the QCU block 112 shown in FIG. 3. referring to FIG. 4, the QCU cell is comprised of a descriptor decoder 300 analyzing transferred descriptor data into information for transferring frames and transferring the analyzed information to a relevant circuit; an address selector maintaining a location of a currently processed descriptor in the memory 310; a DMA manager 320 outputting information of frame addresses and lengths to the DMA controller 114 on basis of information provided from the decoder 300; a queue controller 330 regulating an operation of transferring frames to the transmitter 120 from the memory 130 on basis of data and conditioning information about all blocks; and a pre-buffer 340 composed of a FIFO register temporarily storing and transferring a frame that is provided thereto through transmission request for the QCU cell.

The decoder 300 deciphers the descriptor input thereto, abstracting a next descriptor address NEXT_D_P stored in the transmission queue, an address of the frame header and body FRAME_PTR, a current descriptor length D_LEN, and a current frame length FRAME_LEN from the currently input descriptor as illustrated in FIG. 2. The decoder 300 also informs the queue controller 330 of the presence of the next frame waiting in the corresponding queue.

The address selector 310 has the descriptor address D_PTR of the currently requested frame and informs the DMA manager 320 of the address D_PTR. Such a configuration is provided to maintain the descriptor address that enables the descriptor and frame to be processed in sequence by the QFE 110, because there is a difference between the speed of processing the descriptor by the decoder 300 and the speed of preparing the descriptor and frame by software. And, the address selector 310 inputs and stores the descriptor address of the next frame. The address selector 310 enables a fast queue transfer operation by transferring the descriptor address, which is supplied thereto by way of the transfer of the transmission-confirming signal TX_CONFIRM from the transmitter 120 when completing all procedures of the currently transmitted frame and confirming the transfer of the next frame, to the DMA manager 320. This makes the descriptors be able to control the transferring operations of all frames, offering a queue construction to maximize the operating speed and efficiency.

The DMA manager 320 is provided to generate the frame address DMA_ADDR and the frame length DMA_LEN in the memory 130, which are to be informed to the DMA controller 114 for the queue transmission. The DMA manager 320 first receives the frame address FRAME_PRT, the frame length FRAME_LEN, and the descriptor length D_LEN from the decoder 300, and the descriptor address D_PTR from the address selector 310. After then, the DMA manager 320 transfers the data of the address and length, DMA_ADDR and DMA_LEN, of the frame to be requested. Meanwhile, while establishing the length DMA_LEN to be informed to the DMA controller 114, the DMA manager 320 sets the length to be equal to or shorter than the maximum frame length DMA_MAX_LEN defined by software. For example, if FRAME_LEN is 200 bytes and DMA_MAX_LEN is 128 bytes, the length DMA_LEN is established on 128 bytes at a first step of DMA operation and established on the rest size of the frame, which is 72 bytes, at a second step of DMA operation. The reason why the frame of DMA is not all transferred in one time in accordance with FRAME_LEN is because the pre-buffer described later is configured in a size smaller than that of the frame defined by the specification. But, the more important reason for the DMA frame length restriction is to prevent the DMA controller 114 from being occupied by a specific QCU cell for a long time. With such a DMA frame length restriction, it increases the number of determining the priorities by the QCU arbiter 111 and thereby it enables data to be transferred faster with the access categories of high priorities.

The pre-buffer 340 is a kind of buffer memory that is composed of a FIFO register that temporarily stores the transmission-requested frame until the transmitter 120 is ready for transmission. The pre-buffer 340 outputs the transmission-requested frame to the transmitter 120 and transfers information of data-storage condition to the queue controller 330.

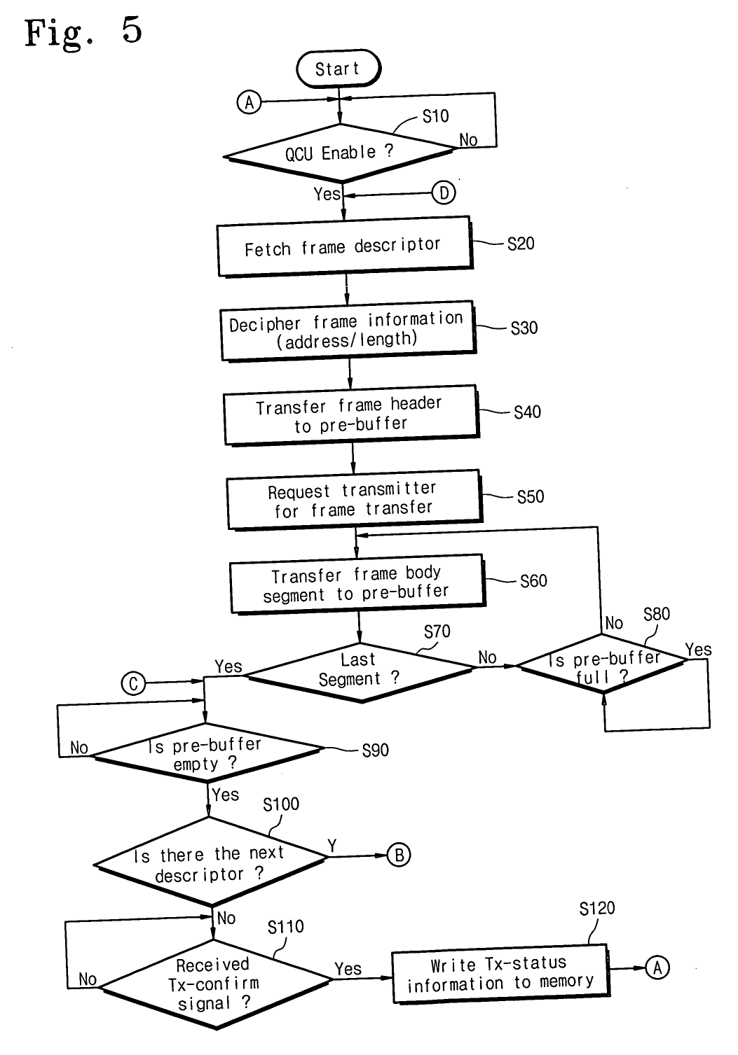

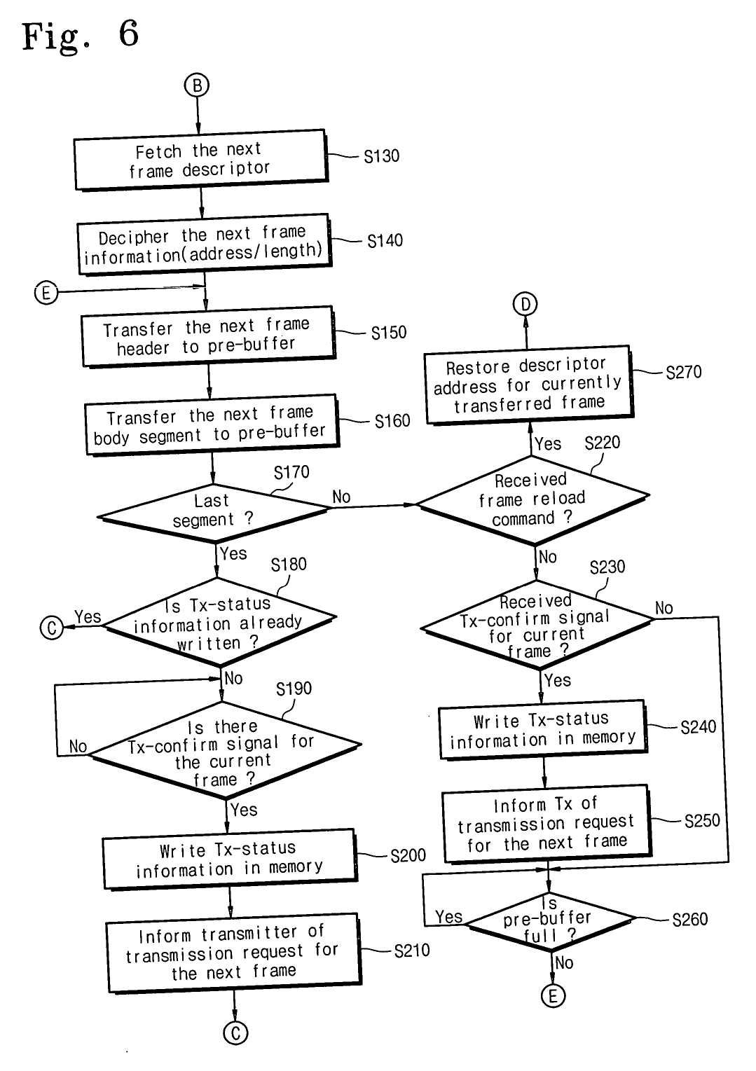

The queue controller 330 acts as a state controller 330 to regulate transfers and conditions of all the descriptors and frames in the QCU cell. Input signals of the queue controller 330 is classified into four types, i.e., information QCU-EN supplied by software, the information signals FULL and EMPTY applied from the pre-buffer 340, the information signal DMA_DONE applied from the DMA controller 114, and the information signals TX_CONFIRM and RELOAD applied from the transmitter 120. From such informational input signals, the queue controller 330 finds out overall transfer states of the descriptors and frames, informs the DMA manager 320 of the information QCU_STATE about which frame is to be transferred by way of DMA, and applies the queue transmission-requesting signal QTX_REQ to the QCU arbiter 111. It will be explained about detailed conditioning operation by the queue controller 111 with reference to the flow charts shown FIGS. 5 and 6.

As such, the QCU cells included in the QCU block 112, being assigned with the priorities by the access categories (AC), operate independently with fetching the descriptors and frames, decipher the read-out descriptor, and request for a frame, corresponding to the decoded descriptor, and a descriptor of the next frame. The frame transferred is temporarily stored in the pre-buffer 340 and transferred to the transmitter 120 when transmission with the currently transferred frame is completed. Meanwhile, if there is a need of re-transferring the frame due to transmission error, it is available to request for the re-transfer toward the DMA controller 114 by means of the descriptor of the currently transferred frame stored in the address selector 310. This independent operation by each of the QCU cells assures an effective frame transmission to satisfy the QoS by means of the queue configuration segmented into dual regions of the descriptor and frame. Further, the media transmission control by means of the priorities by the access categories through the arbiter 111 is characterized in making it possible to assist an operation for dual QoS.

FIGS. 5 and 6 are flow charts showing an operation of controlling the queue controller 330. Referring to FIGS. 5 and 6, the flow chart shows the procedure of processing (i.e., deciphering) the descriptor by the QCU cell, reading the frame assigned to the descriptor, transferring the frame to the transmitter 120 through the pre-buffer 340, and informing the software of the transfer result.

The QCU cell starts to operate with transferring the signal QCN_EN that informs the QCU cells of the beginning of the QCU operation after completing the transmission queue of the descriptors and frames as shown in FIG. 2 (step S10).

The QCU cell reads out the descriptor from a predetermined address by software (step S20). The descriptor decoder 300 abstracts the frame address and length, which are necessary to transfer the frame to the memory 130 from the pre-buffer 330, from the read-put descriptor (step S30). On basis of the abstracted frame information (i.e., address and length) in the memory 130, the frame header is transferred to the pre-buffer 340 from the memory 130 (step S40). The QCU cell requests the transmitter 120 for occupation of transmission channel. The request at the step S40 enables the transmitter 120 to begin an operation to take the transmission channel (step S50). The QCU cell next transfers the frame body segment to the pre-buffer 340. During this, the body of the frame is not fully processed by DMA operation, but the frame designated is requested by the DMA mode in the unit of segment by software. For requests from the QCU cells, the QCU arbiter 111 determines the priorities by the access categories and transfers the frame segments to the pre-buffer 340 through the DMA controller 114 (step S60). After transferring the frame segments to the pre-buffer 340, it checks whether the last frame segment is completely transferred (step S70). If the last frame segment has not been completely transferred to the pre-buffer 340, it finds there is a surplus space in the pre-buffer 340. If the pre-buffer 340 is full, it waits until there is the surplus space capable of accommodating the frame segments in the pre-buffer 340. If the pre-buffer 340 does not have any surplus space therein, not being full, the remaining frame segments are continuously transferred and stored into the pre-buffer 340 (step S80). If the last frame segment is completely transferred to the pre-buffer 340, the all frame segments are transferred to the transmitter 120 from the pre-buffer 340 and then it checks whether the pre-buffer 340 is empty. If the pre-buffer 340 is not empty, it waits until the pre-buffer 340 becomes empty after completely transferring all of the frame segments into the transmitter 120 (step S90). If the pre-buffer 340 is empty after completely transferring all of the frame segments into the transmitter 120, the queue controller 330 finds out there is the next descriptor. IF there is the next descriptor, the procedure goes to routine B shown in FIG. 6. Otherwise, If there is not the next descriptor therein, it waits for the transmission-confirming signal TX_CONFIRM from the transmitter 120 (step S110). The transmission-confirming signal TX_CONFIRM is a reply sent by the transmitter 120 after accepting a response from a receiver for a transmitted frame in a communication system that requires the response to transmission. If the transmission-confirming signal TX_CONFIRM is arrived thereat from the transmitter 120, it stores information about transmission states in the memory 130 and waits until the next descriptor is supplied thereto (step S120).

FIG. 6 is a flow chart showing an operation processing more two descriptors and frames that are continuously arranged in the transmission queue. Referring to FIG. 6, the QCU cell minimizes a transmission stand-by time by processing the next descriptor and transferring the frame without regarding whether the previous frame has been correctly transferred to the transmitter 120. But, it is required of conducting a restoring operation for the frame data after completing the transmission with the current frame or when the transmission with frame is failed, while transferring the next frame to the pre-buffer 340, which will be described as follows.

The QCU cell reads the next descriptor from the memory 130 (step S130), and deciphers the next descriptor to abstract the frame address and length in the memory 130 (step S140). With reference to the abstracted information of the next descriptor, it reads a header of the next frame from the transmission queue composed in the memory 130 and stores the frame header into the pre-buffer 340 (step S150). The QCU cell transfers the body segment of the next frame to the pre-buffer 340 through the DMA controller 114 (step S160). And, it checks whether the last segment of the next frame is transferred and stored in the pre-buffer (step S170). If the currently transferred segment is not the last segment, it conducts steps S220 through S270. If the currently transferred segment is the last segment, it confirms whether there has already been a description of information about transmission state for the current frame (step S180). If there has been received the transmission state information from the transmitter 120, it checks the state of the pre-buffer 340 and returns to the standby routine C. This step is provided to find whether the transmission-confirming signal has arrived and thereby the transmission state has been already written in the memory 130 while transferring the frame segments to the pre-buffer 340. If there is the description of the transmission state in the memory 130, it waits until the transmitter 120 sends the last segment (step S190). If the last segment of the next frame has been transferred to the pre-buffer 340 before the transmission-confirming signal for the current frame arrives thereat from the transmitter 120, it waits until the transmitter 120 sends the last segment held in the pre-buffer 340 (step S220). If the transmission-confirming signal arrives thereat from the transmitter 120, the transmission-confirming signal is stored in the memory (step S200) and a transmission request for the next frame is informed to the transmitter 120 from the pre-buffer 340 (step S210).

If it determines that the current segment is not the last segment of the frame in the step S170, the procedure turns to the step S270 from the step S220. When the transfer operation with frame is failed, the transmitter 120 generates the command signal RELOAD to re-transfer the current frame to the pre-buffer 340 (the step S220). In this case, the QCU cell stops to transfer the next frame to the pre-buffer 340 and begins to return the frame, which is being sent from the transmitter 120, to the pre-buffer 340. In order to do this operation against the failure of frame transfer, it restores an address of the descriptor for the currently transferred frame and returns to the routine D of FIG. 5, corresponding to the first step, to continue the frame transferring operation (step S270).

If the frame is being normally transferred, it checks an arrival of the transmission-confirming signal for the current frame without receiving the command signal RELOAD from the transmitter 120 (step S230). If there is no transmission-confirming signal for the current frame, it turns to step S260 to check a condition of the pre-buffer 340. If the transmission-confirming signal is generated from the transmitter 120, the transmission state information is stored in the memory 130 (step S240) and a transmission request for the next frame is informed to the transmitter 120 (step S250). The QCU cell checks whether the pre-buffer 340 is full after requesting the transmitter 120 for the frame stayed in the pre-buffer 340. If the pre-buffer 340 is full, it waits until the transmitter 120 fetches the frame stored in the pre-buffer 340. If the pre-buffer 340 is not full, a segment of the next frame is transferred to the pre-buffer 340 (step S260).

As aforementioned, including the control operation by the queue controller 330, the four QCU cells, being arranged according to the priorities by the access categories, independently read out the descriptors and frames from the transmission queues composed in the memory 130, store the fetched descriptors and frames in the pre-buffer 340, and then requests the transmitter 120 to transfer the frame stored in the pre-buffer 340. With the architecture of the transmission queue constructed of the descriptor and frame, it is possible that the re-calling operation for the frame to recover a transmission error is conducted faster, and a frame segment to be transferred is always stored into the pre-buffer 340 and immediately transferred in response to the permission for transmission. The priorities are arranged such that when the QCU cells independently generate the transmission-requesting signals, the QCU arbiter 111 selects the highest prior one of the four request signals and transfers the queue corresponding thereto.

Although the invention has been described in connection with the embodiment of the invention illustrated in the accompanying drawings, it is not limited thereto. It will be apparent to those skilled in the art that various substitution, modifications and changes may be thereto without departing from the scope and spirit of the invention.

As described above, the invention enables the frames to be transferred, transmitted, and re-called in easy through the structure of the transmission queues with the descriptors and frames. Each transmission queue is controllable to conduct the aforementioned functions effectively and rapidly by way of analyzing the descriptors. Further, the QCU arbiter allocates the priorities to the transferring order of the frames by the QCU cells, providing the features satisfying the QoS required by the IEEE802.11e.

Meanwhile, the invention is embodied with the apparatus, for controlling the frame transferring operation, which is divisionally implemented in the QCU block 112 and the QCU arbiter 111. Such a divisional control scheme is also advantageous to flexibly confronting with variations in the number and the priorities of the transmission queues, enabling the algorisms for enhancing the QoS and for determining the priorities among the transmission queues in the divisional feature.

What is claimed is:

1. A wireless LAN system comprising:
a memory;
a central processing unit segmenting data, which is to be transferred, into frames, generating descriptors containing frame addresses and lengths in the memory, and storing the segmented frames and the descriptors into the memory in accordance with transmission priorities;
a media accessing controller calling the frames of data, which is to be transferred, from the memory with reference to the transmission priorities and the descriptors, and temporarily storing the frames; and
a transmitter transferring the frames stored in the media accessing controller.

2. The wireless LAN system as set forth in claim 1, wherein the memory comprises:
a descriptor region composed of queues each of which is constructed of the descriptors with the same priority in accordance with an order of input, the queues being arranged in the number of the priorities by quality of service;
a frame header region containing information about frame control in a receiver; and
a frame body region corresponding to a body of the frame data transmitted.

3. The wireless LAN system as set forth in claim 1, wherein the descriptor is data comprising:
positional information of the next descriptor to make the media accessing controller regulate a sequential transfer operation with the frame body and the frame header; and
state information informing a transmission result for a corresponding frame.

4. The wireless LAN system as set forth in claim 2, wherein the frame header region comprises queues of frame headers with the same priority in plural fields by the priorities.

5. The wireless LAN system as set forth in claim 2, wherein the frame body region comprises queues of frame headers with the same priority in plural fields by the priorities.

6. The wireless LAN system as set forth in claim 1, wherein the media accessing controller comprises:
a queue control unit block generating pluralities of transmission-requesting signals;
a queue arbiter selecting the highest prior one from the plural transmission-requesting signals; and
a DMA controller reading a corresponding frame from the memory in compliance with the transmission-requesting signal selected by the queue arbiter.

7. The wireless LAN system as set forth in claim 6, wherein the queue control unit block comprises pluralities of queue control unit cells, independently operating in correspondence with the priorities, each queue control unit cell reading the descriptor corresponding to the priority from the memory, analyzing the fetched descriptor, and generating the transmission-requesting signal containing information of an address and length of the frame.

8. The wireless LAN system as set forth in claim 7, wherein the queue control unit cell comprises:
a descriptor decoder deciphering the descriptor to generate an address and length of the corresponding frame in the memory, presence of the next descriptor standing-by with the same priority, and an address of the next descriptor in the memory if there is the next descriptor;
a DMA manager transferring the frame address and length to the DMA controller from the descriptor decoder;
an address selector providing the address of the next descriptor to the DMA manager when there is a transmission error, assuring re-transmission against the transmission error;
a pre-buffer temporarily storing a transmission-requested frame transferred from the DMA controller and outputting a buffer condition signal; and
a queue controller receiving a transmission-starting signal from the central processing unit, a transmission condition signal from the transmitter, and the buffer condition signal from the pre-buffer, detecting a transfer condition of the frame, and regulating the sequential transfer operation of the frame from the memory to the transmitter in accordance with a result of the detection.

9. The wireless LAN system as set forth in claim 8, wherein the queue controller outputs the transmission-requesting signal for the next frame in response to a transmission-confirming signal for the corresponding frame and a presence-confirming signal for the next descriptor from the transmitter.

10. The wireless LAN system as set forth in claim 8, wherein the queue controller enabling the frame to be re-transferred from a first segment, by controlling a descriptor address of a currently transferred frame to be output to the DMA manager from the address selector, when there is a request of re-transfer for the currently transferred frame sent from the transmitter.

11. The wireless LAN system as set forth in claim 8, wherein the queue control unit cell continuously controls transferring the frame until all of the queues to be transferred are absent, referring to a position of the next descriptor with the priority corresponding to the queue control unit cell in the memory by way of deciphering the descriptor given initially.

12. The wireless LAN system as set forth in claim 6, wherein the media accessing controller reads out the frame from the memory, stores the frame in a buffer, and transmitting the frame, in response to the transmission-requesting signals independently generated from the plural queue control unit cells, assuring a media accessing control operation satisfying quality of service.

13. A method of controlling media access, comprising:
segmenting data, which are to be transferred, into frames in the unit of transmission;
generating descriptors, which include frame addresses and lengths, from the segmented frame;
storing pluralities of transmission queues that include the frames and descriptors arranged by priorities;
reading pluralities of initial descriptors of a designated one of the frames, being arranged by the priorities, after completing the transmission queues;
generating pluralities of transmission-requesting signals for the frames with reference to the addresses and lengths of the plural frames in the memory, the addresses and lengths being obtained from deciphering the pluralities of the initial descriptors arranged by the priorities;
temporarily storing a corresponding one of the frames from the memory in response first to the highest prior one among the plural transmission-requesting signals; and
transmitting the temporarily stored frame at a transmittable time.

14. The method as set forth in claim 13, wherein the descriptor further includes: a descriptor position of the next frame; and state information informing a result of transmission.

15. The method as set forth in claim 13, wherein the transmission queue of the descriptor composed in the memory is constructed with a single queue in accordance with an input order of the descriptors with the same priority, the queues being in number of the priorities assigned each to kinds of the frames.

16. The method as set forth in claim 13, wherein the descriptor, including information for transmitting the next descriptor that is waiting, is configured to enable a sequential frame control operation until completely transferring all of the queues with the same priority prepared by deciphering the initial descriptor.

17. The method as set forth in claim 13, wherein when there is a request for a re-transfer operation of the frame from a transmitter due to a transmission error, the re-transfer operation is promptly carried out with all information by means of restoring the descriptor of a corresponding one of the frames.
